(19) United States
(12) Patent Application Publication
(10) Pub. No.: US 2010/0315350 A1
(43) Pub. Date: Dec. 16, 2010

(54) MOUSE PAD HAVING DISPLAY

(75) Inventors: Marc B. Rene, Rochester, NY (US); Alan Robert Dawson, Webster, NY (US)

Correspondence Address: PEPPER HAMILTON LLP, 500 GRANT STREET, ONE MELLON CENTER, 50TH FLOOR, PITTSBURGH, PA, 15219, US

(73) Assignee: XEROX CORPORATION, Norwalk, CT (US)

(21) Appl. No.: 12/484,677

(22) Filed: Jun. 15, 2009

(51) Int. Cl. G06F 3/041

(52) U.S. Cl. 345/173

(57) ABSTRACT

Systems for displaying an image on a mouse pad are disclosed. A system for displaying an image on a mouse pad may include a processor and a mouse pad. The mouse pad may include a top surface and an electric writeable medium. The top surface is a surface configured to enhance the usability of a computer mouse that is disposed above the electric writeable medium. The electric writeable medium is in operable communication with the processor and is configured to display an image.

### BACKGROUND

The present disclosure generally relates to mouse pads and display elements. More specifically, the present disclosure relates to mouse pads including a display formed from an electric writeable medium including, for example and without limitation, rotatable elements, electronic ink, or the like.

Mouse pads are utilized in conjunction with millions of desktop computing systems worldwide. Many mouse pads have a static brand or marketing message printed on the top surface of the mouse pad. A brand or marketing message can, over time, become dated, inapposite or otherwise incorrect as the company that initially provided the message changes its marketing slogans, images or the like. As such, static messages represent a potential issue for companies that provide or sell mouse pads to customers.

Traditional signs are based upon printed materials, paper, plastic, metal, or the like, and are therefore neither programmable nor easily changed. In an attempt to overcome this problem, electronically programmable and/or controllable signs have been developed. For example, liquid crystal diode (LCD) displays and cathode ray tube (CRT) displays will display an image in response to applied electric signals or fields. However, such LCD and CRT displays typically require a substantial amount of electricity because they must provide illumination in order to be visible to a viewer.

Other types of electric writeable media, known as rotatable element displays or electric paper displays, also exist. One example of a rotatable element display includes a polymer substrate and bichromal rotatable elements such as balls or cylinders that are in suspension with an enabling fluid and are one color, such as white, on one side and a different color, such as black, on the other. Under the influence of an electric field, the elements rotate so that either the white side or the black side is exposed. Examples of such rotatable element displays are described, for example, in U.S. Pat. No. 5,723,204 to Stefik and U.S. Pat. No. 5,604,027 to Sheridon, each of which is incorporated herein by reference in its entirety.

Another type of electric writeable media is known as an electronic ink display, such as the one described in U.S. Pat. No. 6,518,949 to Drzaic, which is incorporated herein by reference. An electronic ink display includes at least one capsule filled with a plurality of particles, made of a material such as titania, and a suspending fluid containing dye. When a direct-current electric field of an appropriate polarity is applied across the capsule, the particles move to a viewed surface of the display and scatter light. When the applied electric field is reversed, the particles move to the rear surface of the display and the viewed surface of the display then appears dark.

Yet another type of electric writeable media, also described in U.S. Pat. No. 6,518,949 to Drzaic, includes a first set of particles and a second set of particles in a capsule. The first set of particles and the second set of particles have contrasting optical properties, such as contrasting colors, and can have, for example, differing electrophoretic properties. The capsule also contains a substantially clear fluid. The capsule has electrodes disposed adjacent to it connected to a voltage source, which may provide an alternating-current field or a direct-current field to the capsule. Upon application of an electric field across the electrodes, the first set of particles move toward one electrode, while the second set of particles move toward the second electrode.

Electric writeable media have numerous advantages over conventional displays, such as LCDs and CRTs, because they are suitable for viewing in ambient light, retain an image for long periods of time in the absence of an applied electric field, and are typically very lightweight and/or flexible. For further advantages of such displays, see U.S. Pat. No. 5,389,945 to Sheridon, which is incorporated herein by reference in its entirety.

FIG. 1 depicts the switching behavior of an electric writeable medium including rotatable elements according to the known art. The electric writeable medium includes a plurality of rotatable elements, such as bichromal balls. Each rotatable element, such as 10, has a first-colored hemisphere 12, such as black, and a second-colored hemisphere 14, such as white. Typically, the black hemisphere 12 is positively charged and the white hemisphere 14 is negatively charged. As such, the rotatable element 10 has an electrical dipole charge that causes the rotatable element to rotate upon the application of an external electric field.

Typically, the charge of one hemisphere of a rotatable element 10 has a greater magnitude than the charge of the other hemisphere. Thus, each rotatable element 10 has an electrical monopole charge, which is defined as the algebraic sum of the hemispherical charges. The electrical monopole charge causes the rotatable element 10 to move across the cavity 16 when an external electric field is applied.

During quiescent periods, a combination of electrical, hydraulic and mechanical forces may attach a rotatable element 10 to a wall (e.g., 18, 18′) of a cavity 16 in which it resides. The electrical monopole charge causes the rotatable element 10 to separate from a cavity wall (e.g., 18) and move to the opposite cavity wall (e.g., 18′) in the presence of an external electric field. Once free from the cavity wall, the electrical dipole charge interacts with the external electric field to cause the rotatable element 10 to rotate into alignment with the electric field. When the rotatable element 10 reaches the opposite cavity wall (e.g., 18′), it becomes removably attached to the wall, and rotation ceases. Accordingly, the electrical monopole charge has been recognized as a desired feature of prior art electric writeable medium switching behavior.

### SUMMARY

Before the present systems, devices and methods are described, it is to be understood that this disclosure is not limited to the particular systems, devices and methods described, as these may vary. It is also to be understood that the terminology used in the description is for the purpose of describing the particular versions or embodiments only, and is not intended to limit the scope.

It must also be noted that as used herein and in the appended claims, the singular forms “a,” “an,” and “the” include plural references unless the context clearly dictates otherwise. Thus, for example, reference to an “image” is a reference to one or more images and equivalents thereof known to those skilled in the art, and so forth. Unless defined otherwise, all technical and scientific terms used herein have the same meanings as commonly understood by one of ordinary skill in the art. Although any methods, materials, and devices similar or equivalent to those described herein can be used in the practice or testing of embodiments, the preferred methods, materials, and devices are now described. All publications mentioned herein are incorporated by reference. Nothing herein is to be construed as an admission that the embodiments described herein are not entitled to antedate such disclosure by virtue of prior invention. As used herein, the term “comprising” means “including, but not limited to.”

In an embodiment, a system for displaying an image on a mouse pad may include a processor, and a mouse pad comprising a top surface and an electric writeable medium in operable communication with the processor. The top surface is configured to enhance usability of a computer mouse. The electric writeable medium is configured to display an image and is disposed beneath the top surface of the mouse pad.

In an embodiment, a system for displaying an image on a mouse pad may include a processor, a mouse pad comprising a top surface and an electric writeable medium, and a storage medium in operable communication with the processor. The top surface is configured to enhance usability of a computer mouse. The electric writeable medium is in operable communication with the processor and is disposed beneath the top surface. The storage medium may include one or more programming instructions that cause the processor to transmit first data and second data to the mouse pad. The first data causes the electric writeable medium to display a first image. The second data causes the electric writeable medium to display a second image.

### BRIEF DESCRIPTION OF THE DRAWINGS

Aspects, features, benefits and advantages of the present invention will be apparent with regard to the following description and accompanying drawings, of which:

FIG. 1 depicts the switching behavior of an electric writeable medium including rotatable elements according to the known art.

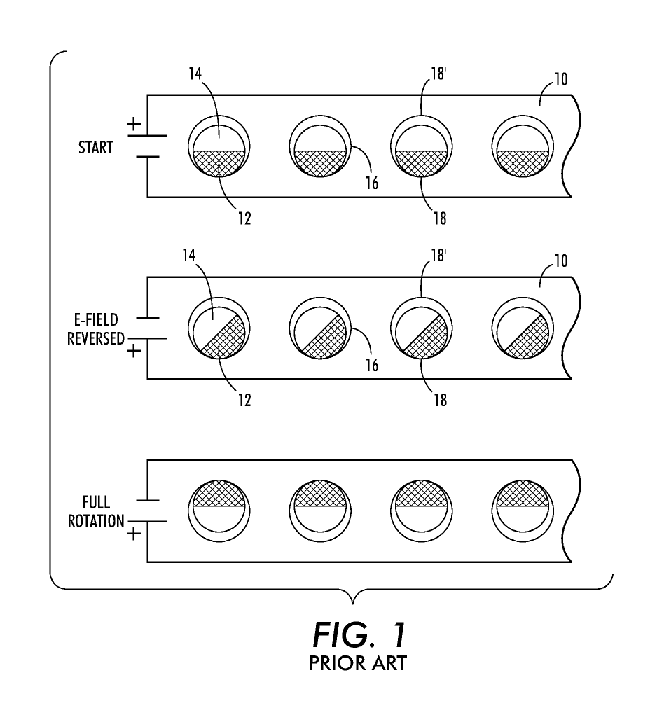

FIG. 2 depicts a block diagram for a computing system including an exemplary mouse pad according to an embodiment.

FIG. 3 depicts a block diagram for an alternate system including an exemplary mouse pad according to an embodiment.

FIG. 4 depicts a block diagram of exemplary internal hardware that may be used to contain or implement program instructions according to an embodiment.

### DETAILED DESCRIPTION

The following terms shall have, for the purposes of this application, the respective meanings set forth below.

An “electric writeable medium” refers to a device or portion of a device containing one or more elements that can be electrically controlled to produce an image. The one or more elements may include capsules containing rotatable elements, electronic ink or the like. Each capsule may have associated electrodes that are configured to provide an electric field across the capsule, when activated. The rotatable elements, electronic ink or other substance within the capsule may react in the presence of an electric field to display one of a plurality of colors based on the polarity and/or intensity of the electric field. If no electric field is present, the rotatable elements, electronic ink or other substance may substantially retain its current orientation with respect to the capsule and, therefore, retain a displayed image. In the aggregate, the alignment of rotatable elements, electronic ink or other substances within a plurality of capsules may be used to form an image, including a picture, a graphic, text and/or the like, on a visible surface of the electric writeable medium.

A “mouse pad” refers to a surface for enhancing the usability of a computer mouse.

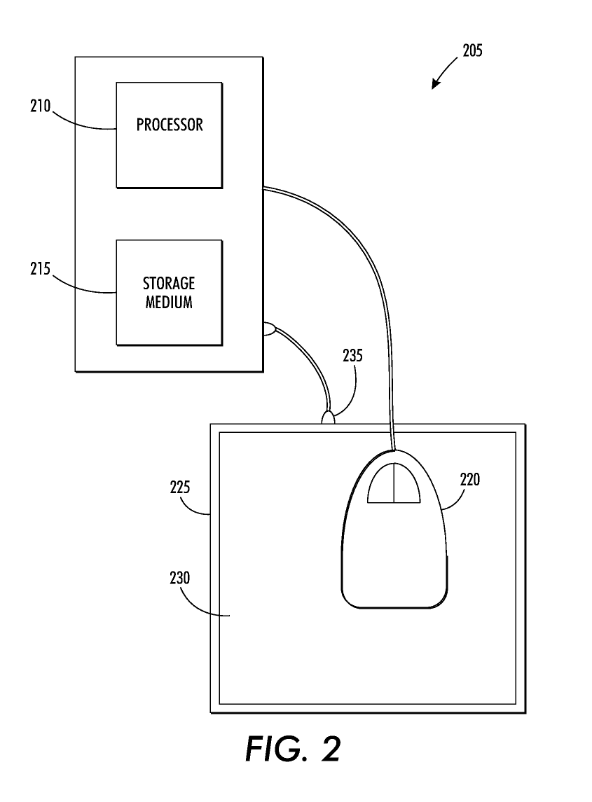

FIG. 2 depicts a block diagram of a computing system including an exemplary mouse pad according to an embodiment. As shown in FIG. 2, the computing system 205 may include a processor 210, a storage medium 215, a mouse 220 and a mouse pad 225. The storage medium 215 may include one or more memory devices and may be in operable communication with the processor 210. The storage medium 215 may include one or more programming instructions for execution by the processor 210. The storage medium 215 may further include data that is intended to be transferred to an electric writeable medium, such as 230, for the purpose of causing an image to be displayed on the electric writeable medium.

The mouse pad 225 may include an electric writeable medium 230 configured to display an image and a top surface. In an embodiment, the mouse pad 225 may be in operable communication with and receive information from the processor 210 that is used to cause an image to be displayed on the electric writeable medium 230. The image may include one or more of a graphical image, content received from a computer network, a stock quote, date/time information, advertising information, an image associated with a game, information pertaining to a operation being performed by the computing system 205, such as a print job status, and/or the like.

The top surface of the mouse pad 225 is configured to enhance the usability of the computer mouse 220. The top surface of the mouse pad 225 is sufficiently scratch resistant to withstand harmful effects that would otherwise result from frictional contact with the mouse 220. For example, the top surface may be made of a scratch-resistant material that is substantially transparent, such as a plastic. The top surface may prevent the mouse 220 from contacting the electric writeable medium 230, which is disposed beneath the top surface, during

In an embodiment, the electric writeable medium 230 of the mouse pad 225 may include a plurality of capsules each containing a rotatable element, such as a bichromal ball. In an alternate embodiment, the electric writeable medium 230 may include a plurality of capsules each containing electronic ink.

In an embodiment, the mouse pad 225 may be connected to the processor 210 via a wired connection 235, such as a Universal Serial Bus (USB) cable. In such an embodiment, the mouse pad 225 may receive power via the wired connection 235. In general, a wired connection 235 may be used to provide image data and/or power to the electric writeable medium 230.

In an alternate embodiment, the mouse pad 225 may be in operable communication with the processor 210 via a wireless transceiver, such as an infrared transceiver, a Bluetooth transceiver, a Radio Frequency Identification (RFID) transceiver or the like. In such an embodiment, the mouse pad 225 may receive power from, for example and without limitation, an external power source or an internal battery (not shown).

In an embodiment, the storage medium 215 may include one or more programming instructions for causing the processor 210 to transmit data to the mouse pad 225. In particular, the one or more programming instructions may cause the processor 210 to transmit first data to the mouse pad 225, where the first data is configured to cause the electric writeable medium 230 to display a first image. After the first image has been displayed, the one or more programming instructions may cause the processor 210 to transmit second data to the mouse pad 225, where the second data is configured to cause the electric writeable medium 230 to display a second image. As such, the one or more programming instructions stored in the storage medium 215 may cause the processor 210 to transmit data to the mouse pad 225 at a plurality of times that is configured to cause the electric writeable medium 230 to consecutively display a plurality of images.

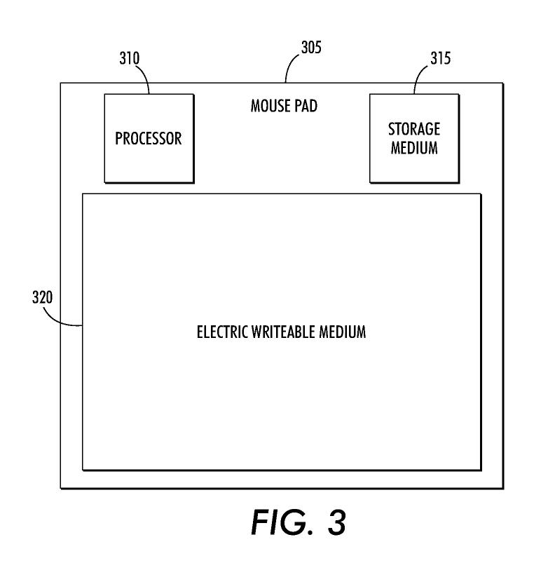

FIG. 3 depicts a block diagram for an alternate system including an exemplary mouse pad according to an embodiment. As shown in FIG. 3, the system may include a mouse pad 305 including a processor 310, a storage medium 315 and an electric writeable medium 320. The storage medium 315 may include one or more memory devices and may be in operable communication with the processor 310. The storage medium 315 may include one or more programming instructions for execution by the processor 310. The storage medium 315 may further include data that is intended to be transferred to an electric writeable medium, such as 320, for the purpose of causing an image to be displayed on the electric writeable medium.

The electric writeable medium 320 may be configured to display an image. In an embodiment, the electric writeable medium 320 may be in operable communication with and receive information from the processor 310 that is used to cause an image to be displayed on the electric writeable medium. The image may include one or more of a graphical image, content received from a computer network, a stock quote, date/time information, advertising information, an image associated with a game, information pertaining to a operation being performed by a remote computing system and/or the like.

In an embodiment, the electric writeable medium 320 may include a plurality of capsules each containing a rotatable element, such as a bichromal ball. In an alternate embodiment, the electric writeable medium 320 may include a plurality of capsules each containing electronic ink.

In an embodiment in which the processor 310 and the storage medium 315 are located within the mouse pad 305, the need for having a persistent connection between the mouse pad and a computing device may be obviated. As such, the mouse pad 305 may not be persistently connected to a remote computing system. Rather, the mouse pad 305 may merely include a power cord. In an alternate embodiment, an internal power source, such as a battery, may also be used within the scope of this disclosure.

A wireless or wired communication link may be provided when new image data is to be stored in the storage medium 315. For example, the mouse pad 305 may be connected to a computing device via a wired connection, such as a USB cable, when new image data is to be downloaded. In an alternate embodiment, the mouse pad 305 may be in operable communication with a computing device via a wireless transceiver, such as an infrared transceiver, a Bluetooth transceiver, an RFID transceiver or the like, to download new image data.

In an embodiment, the storage medium 315 may include one or more programming instructions for causing the processor 310 to display images on the electric writeable media 320. In particular, the one or more programming instructions may cause data to be sent from the processor 310 to the electric writeable media 320 to display a first image on the electric writeable media. After the first image has been displayed, the one or more programming instructions may cause data to be sent from the processor 310 to the electric writeable media 320 to display a second image on the electric writeable media. As such, the one or more programming instructions stored in the storage medium 315 may cause the processor 310 to consecutively display a plurality of images on the electric writeable medium 320.

The top surface of the mouse pad 305 is configured to enhance the usability of a computer mouse. The top surface of the mouse pad 305 is sufficiently scratch resistant to

Although processors 210, 310, optionally in operable communication with storage media 215, 315, are described in the above embodiments as means for providing image data to electric writeable media 230, 320, any image data source may provide image data to an electric writeable medium in a mouse pad 225, 305 within the scope of this disclosure. For example, the image data source may include a digital camera, a flash memory, a video camera, a DVD player, a Blu-ray™ player and/or any other data source.

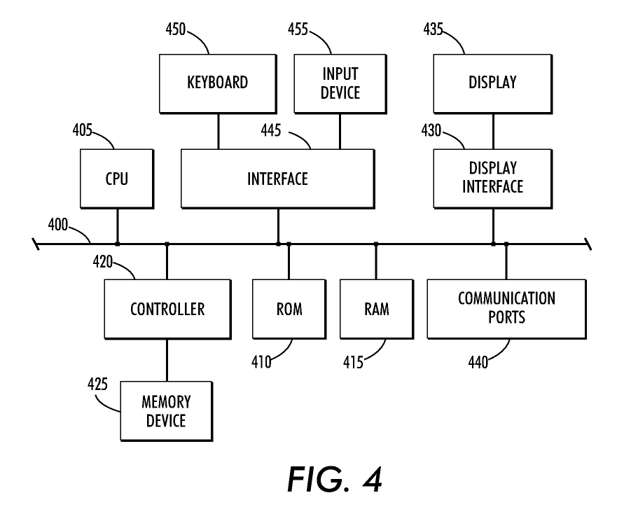

FIG. 4 depicts a block diagram of exemplary internal hardware that may be used to contain or implement program instructions according to an embodiment. A bus 400 serves as the main information highway interconnecting the other illustrated components of the hardware. CPU 405 is the central processing unit of the system, performing calculations and logic operations required to execute a program. Read only memory (ROM) 410 and random access memory (RAM) 415 constitute exemplary memory devices (i.e., storage media).

A controller 420 interfaces with one or more optional memory devices 425 to the system bus 400. These memory devices 425 may include, for example, an external or internal DVD drive, a CD ROM drive, a hard drive, flash memory, a USB drive or the like. As indicated previously, these various drives and controllers are optional devices.

Program instructions may be stored in the ROM 410 and/or the RAM 415. Optionally, program instructions may be stored on a tangible storage medium such as a compact disk, a digital disk, flash memory, a memory card, a USB drive, an optical disc storage medium, such as Blu-ray™ disc, and/or other recording medium.

An optional display interface 430 may permit information from the bus 400 to be displayed on the display 435 in audio, visual, graphic or alphanumeric format. Communication with external devices may occur using various communication ports 440. An exemplary communication port 440 may be attached to a communications network, such as the Internet or an intranet.

The hardware may also include an interface 445 which allows for receipt of data from input devices such as a keyboard 450 or other input device 455 such as a mouse, a joystick, a touch screen, a remote control, a pointing device, a video input device and/or an audio input device.

An embedded system may optionally be used to perform one, some or all of the operations described herein. Likewise, a multiprocessor system may optionally be used to perform one, some or all of the operations described herein.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the disclosed embodiments.

What is claimed is:

1. A system for displaying an image on a mouse pad, comprising:
a processor; and
a mouse pad comprising a top surface and an electric writeable medium, wherein the top surface is configured to enhance usability of a computer mouse, wherein the electric writeable medium is in operable communication with the processor, is configured to display an image, and is disposed beneath the top surface.

2. The system of claim 1 wherein the mouse pad is physically separated from the processor.

3. The system of claim 2 wherein the mouse pad is in wired communication with the processor.

4. The system of claim 2 wherein the mouse pad is in wireless communication with the processor.

5. The system of claim 1 wherein the mouse pad is configured to receive power via a wired connection with the processor.

6. The system of claim 1 wherein the mouse pad is configured to receive image data from the processor, wherein the image data is configured to cause an image to be displayed on the electric writeable medium.

7. The system of claim 6 wherein the image comprises one or more of the following:
a photographic image;
content received from a computer network;
a stock quote;
date/time information;
advertising information; and
an image associated with a game.

8. The system of claim 1 wherein the electric writeable medium comprises a rotatable element.

9. The system of claim 1 wherein the electric writeable medium comprises electronic ink.

10. The system of claim 1 wherein the top surface of the mouse pad comprises a scratch-resistant plastic.

11. A system for displaying an image on a mouse pad, comprising:
a processor;
a mouse pad comprising a top surface and an electric writeable medium, wherein the top surface is configured to enhance usability of a computer mouse, wherein the electric writeable medium is in operable communication with the processor and is disposed beneath the top surface; and
a storage medium in operable communication with the processor,
wherein the storage medium comprises one or more programming instructions for:
transmitting, by the processor, first data to the mouse pad, wherein the first data is configured to cause the electric writeable medium to display a first image; and
transmitting, by the processor, second data to the mouse pad, wherein the second data is configured to cause the electric writeable medium to display a second image.

12. The system of claim 11 wherein the mouse pad is physically separated from the processor.

13. The system of claim 12 wherein the mouse pad is in wired communication with the processor.

14. The system of claim 12 wherein the mouse pad is in wireless communication with the processor.

15. The system of claim 11 wherein the mouse pad is configured to receive power via a wired connection with the processor.

16. The system of claim 11 wherein at least one of the first image and the second image comprises one or more of the following:
a photographic image;
content received from a computer network;
a stock quote;
date/time information;
advertising information; and
an image associated with a game.

17. The system of claim 11 wherein the electric writeable medium comprises a rotatable element.

18. The system of claim 11 wherein the electric writeable medium comprises electronic ink.

19. The system of claim 11 wherein the top surface of the mouse pad comprises a scratch-resistant plastic.

20. A free standing mouse pad for use with a computer mouse, comprising:
a top surface configured to enhance the usability of the computer mouse; and
an electric writable medium disposed beneath the top surface, wherein the electric writable medium is visible through the top surface and communicable with an image data source so that, when image data is supplied to the electric writable medium from the image data source, an image is visible through the top surface.
